(19) United States
(12) Patent Application Publication
(10) Pub. No.: US 2024/0422604 A1
(43) Pub. Date: Dec. 19, 2024

(54) EVENT BASED BEAM REPORT

(71) Applicant: APPLE INC., Cupertino, CA (US)

(72) Inventors: Yushu Zhang, Beijing (CN); Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Seyed Ali Akbar Fakoorian, San Diego, CA (US); Wei Zeng, Saratoga, CA (US)

(21) Appl. No.: 18/706,445

(22) PCT Filed: Nov. 5, 2021
(86) PCT No.: PCT/CN2021/128985

§ 371 Date: May 1, 2024

(51) Int. Cl. H04W 24/10; H04B 7/06; H04B 17/318; H04W 52/36

(52) U.S. Cl. CPC H04W 24/10; H04B 7/0626; H04B 17/328; H04W 52/365

(57) ABSTRACT

Communication systems may support beam specific P-MPR and enhanced group based beam reporting. A UE may monitor a P-MPR reference for changes in P-MPR value and trigger a P-MPR report procedure for the multiple beams based on the changes in the P-MPR value. Further, the UE may determine that a trigger event for group based beam report has occurred and send a scheduling request configured for group based beam report triggering.

### TECHNICAL FIELD

This application relates generally to wireless communication systems, including power management maximum power reduction (P-MPR) reporting and enhanced group based beam reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an example architecture of a wireless communication system, according to embodiments disclosed herein.

FIG. 5 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

5G standards support beam-specific power management maximum power reduction (P-MPR) reporting. Beam-specific P-MPR reporting is to facilitate the beam selection with regard to maximum power emission (MPE). For example, a UE may apply a power back off for an emission safety issue and may indicate that power reduction with P-MPR. For instance, if one beam of a plurality beams transmitted by the UE is targeting towards a human body the UE may reduce the transmission power of that one beam. The power reduction is beam specific as the other beams may be facing different directions and may not need to reduce transmission power. The UE can report P-MPR for the beams to the network node, and the network node can consider the P-MPR for each beam when configuring a beam for uplink transmission. The UE can report multiple Synchronization Signal Block (SSB) resource indicator (SSBRI) or Channel-State Information Reference Signal (CSI-RS) resource indicator (CRI) as well as corresponding P-MPR by Medium Access Control Coverage Enhancement (MAC CE). The network node can configure a list of SSB/CSI-RS pools for the P-MPR report by Radio Resource Control (RRC).

In some embodiments, the P-MPR is UE specific. The UE specific P-MPR can be reported when the following event occurs if the mpe-Reporting-FR2 is configured, and mpe-ProhibitTimer is not running. The event to trigger a UE specific P-MPR occurs when either: 1. the measured P-MPR applied to meet FR2 MPE requirements is equal to or larger than an mpe-Threshold for at least one activated FR2 Serving Cell since the last transmission of a power headroom report (PHR) in this MAC entity; or 2. the measured P-MPR applied to mect FR2 MPE requirements has changed more than phr-Tx-PowerFactorChange dB for at least one activated FR2 Serving Cell since the last transmission of a PHR due to the measured P-MPR applied to meet MPE requirements being equal to or larger than mpe-Threshold in this MAC entity.

However, the UE specific P-MPR procedure does not account for multiple beams. Described herein are embodiments for beam specific P-MPR procedure. Some embodiments define a triggering event for a beam specific P-MPR procedure. Further, in some embodiments the UE may not be able to measure P-MPR for many beams at a time as the P-MPR measurement complexity is high. Some embodiments herein describe methods for reducing the number of beams for the UE to measure P-MPR.

Additionally, 5G standards support enhanced group based beam reporting. For enhanced group based beam reporting, the UE can report Layer 1 (L1) Reference Signal Received Power (RSRP) for multiple pairs of Synchronization Signal Block Resource Indicators (SSBRIs) or Channel-State Information Resource Indicators (CRIs) that can be simultaneously received. Each reported beam pair may comprise two SSBRIs or CRIs and two corresponding L1-RSRPs. The UE may further report for each pair of beams a maximum number of downlink (DL) layers or whether the two SSBRIs/CRIs are received from the same panel or different panels. The report may be transmitted by the UE by an uplink control information (UCI) carried by PUSCH or PUCCH. The report can be triggered by a network node through RRC (for periodic report) or MAC CE (for semi-persistent report) or DCI (for aperiodic report) signaling.

However, after the enhanced group based beam report something may change and the UE may not be able to receive a reported beam pair. For example, due to rotation or movement of the UE, UE may not always receive the beam pairs with one panel or two panels as reported. Because of something that happened at the UE, the receiving status could be changed and the previous beam report may become invalid. Embodiments herein describe procedures to report the UE status change.

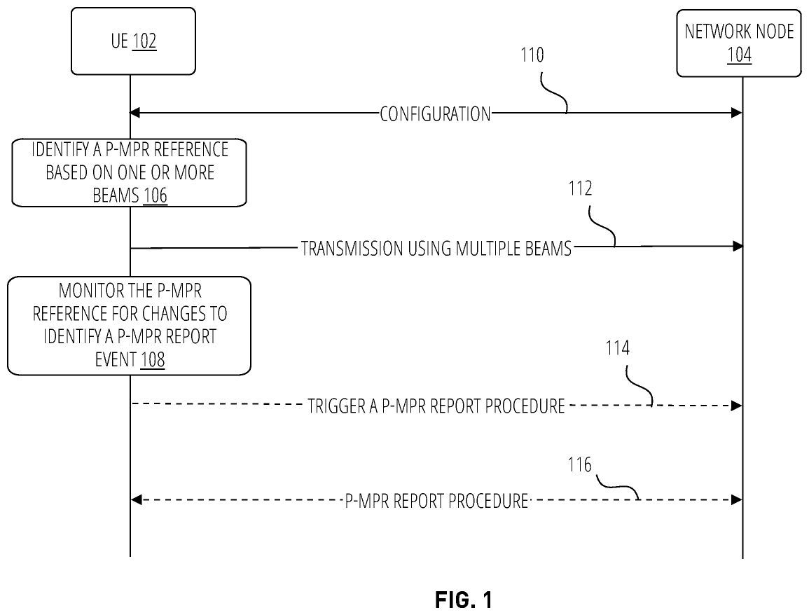

FIG. 1 is a simplified signal flow diagram of an example method for triggering a P-MPR procedure. The UE 102 and the network node 104 may perform a configuration procedure 110 to determine which beams from a plurality of beams should be used for UE transmission 112. As part of the configuration procedure 110, the UE 102 may provide a P-MPR report that is beam specific for each of the beams in the plurality of beams. The UE 102 may identify 106 a P-MPR reference based on one or more beams.

The P-MPR reference may be used by the UE 102 to determine when the UE 102 should provide the network node 104 with a new P-MPR report. For example, the UE 102 may monitor 108 the P-MPR reference for changes to identify a P-MPR report event. When the P-MPR reference or a change in the P-MPR reference exceeds a threshold, the UE 102 may trigger 114 a P-MPR report procedure. During the P-MPR report procedure 116, the UE 102 may provide the network node 104 with an updated P-MPR report.

In some embodiments, for the UE 102 to be configured to identify the P-MPR report event, the P-MPR report is enabled and prohibit timer is not running. For example, a condition for configuring the UE 102 to identify the P-MPR report event, mpe-Reporting-FR2 may be configured, and mpe-ProhibitTimer is not running.

In a first embodiment, the one or more of the multiple beams to be used for the P-MPR reference to detect a P-MPR report event comprises one SSB or CSI-RS out of a pool of SSBs or CSI-RSs configured by RRC. The P-MPR report event that the UE 102 is monitoring for may be when either: 1. the P-MPR for one of the SSBs/CSI-RSs configured in the pool configured by RRC is larger than or equal to a threshold (e.g. mpe-Threshold); or 2. the P-MPR change for the SSB or CSI-RS is larger than or equal to a threshold (e.g. phr-Tx-PowerFactorChange). The thresholds that the P-MPR and the P-MPR change are compared against may be configured by a network node by RRC. When either of these thresholds are met or exceeded, the UE can trigger the P-MPR report procedure.

The one SSB or CSI-RS to be used as the P-MPR reference may be chosen or identified in a variety of ways. In some embodiments, the one SSB or CSI-RS can be any one of the SSBs or CSI-RSs configured by RRC. In some embodiments, the one SSB or CSI-RS can be any one of the SSBs or CSI-RSs reported by the MAC CE. In some embodiments, the one SSB or CSI-RS can be the one SSB or CSI-RS with highest L1-RSRP among the SSBs or CSI-RSs configured by RRC. In some embodiments, the one SSB or CSI-RS can be the one SSB or CSI-RS with a highest modified L1-RSRP (e.g. L1-RSRP-P-MPR) among the SSBs or CSI-RSs configured by RRC. In some embodiments, the one SSB or CSI-RS can be the one SSB or CSI-RS with the highest virtual PHR among the SSBs or CSI-RSs configured by RRC. The virtual PHR may be measured based on a reported P-MPR or measured based on the L1-RSRP or L3-RSRP for the SSB or CSI-RS. In some embodiments, the one SSB or CSI-RS can be any SSB or CSI-RS with a L1-RSRP, modified L1-RSRP, or virtual PHR larger than a threshold. The threshold may be configured by the network node 104.

Additionally, one or more of the options for selecting the one SSB or CSI-RS as the P-MPR reference may be supported by the UE 102 and network node 104. If multiple options for the P-MPR reference selection are available, selection among the options may depend on RRC configuration from the network node 104. For instance, if there is support for both the one SSB or CSI-RS can be any one of the SSBs or CSI-RSs configured by RRC, and the one SSB or CSI-RS can be any one of the SSBs or CSI-RSs reported by the MAC CE.

In a second embodiment, the P-MPR reference to detect a P-MPR report event comprises the maximum, minimal, or average P-MPR for some SSBs or CSI-RSs (e.g., a set or subset of SSBs or CSI-RSs) in the pool configured by RRC. The P-MPR report event that the UE 102 is monitoring for may be when either: 1. maximum, minimal, or average P-MPR for some SSBs or CSI-RSs in the pool configured by RRC is larger than or equal to a threshold (e.g. mpe-Threshold); or 2. the maximum, minimal, or average P-MPR change for the set of SSBs or CSI-RSs is larger than or equal to a threshold (e.g. phr-Tx-PowerFactorChange). The thresholds may be configured by a network node by RRC. When either of these thresholds are met or exceeded by the maximum, minimal, or average P-MPR for the set of SSBs or CSI-RSs or the maximum, minimal, or average P-MPR change or the set of SSBs or CSI-RSs, the UE can trigger the P-MPR report procedure.

The set of SSBs or CSI-RSs used for determining the maximum, minimal, or average P-MPR and maximum, minimal, or average P-MPR change for the reference P-MPR may be chosen or identified in a variety of ways. The set of SSBs or CSI-RSs may include two or more SSBs or CSI-RSs. In some embodiments, the set of SSBs or CSI-RSs can be all of the SSBs or CSI-RSs. In some embodiments, the set of SSBs or CSI-RSs can be SSBs or CSI-RSs with a L1-RSRP, modified L1-RSRP, or virtual PHR larger than a threshold configured by a network node. The values used to as the P-MPR change and the P-MPR can be any combination of a maximum, minimal, or average of the P-MPRs of the set of SSBs or CSI-RSs.

In a third embodiment, the UE 102 can trigger the P-MPR report when either: 1. the P-MPR for a SSB or CSI-RS configured in one of the active uplink (UL) or joint Transmission Configuration Indicator (TCI) States (e.g., TCI state or beam used for current transmission) is larger than or equal to a threshold (e.g. mpe-Threshold) configured by RRC; or 2. the P-MPR change for the SSB or CSI-RS configured in one of the active UL or joint TCI States is larger than or equal to a threshold (e.g. phr-Tx-PowerFactorChange) configured by RRC.

The UL or joint TCI states may be chosen or identified in a variety of ways. In some embodiments, the active UL or joint TCI could be any UL or joint TCI State activated by MAC CE. Thus, the active UL or joint TCI may be selected by the UE from a pool of the UL or joint TCI State activated by MAC CE. In some embodiments, the active UL or joint TCI may be an UL or joint TCI State indicated for current uplink transmission. The SSB or CSI-RS configured for the P-MPR report may include the SSB or CSI-RS configured in the active UL or joint TCI State. Alternatively, the UE 102 may report an additional P-MPR for the TCI State as well as the TCI State ID by MAC CE for a beam specific P-MPR report.

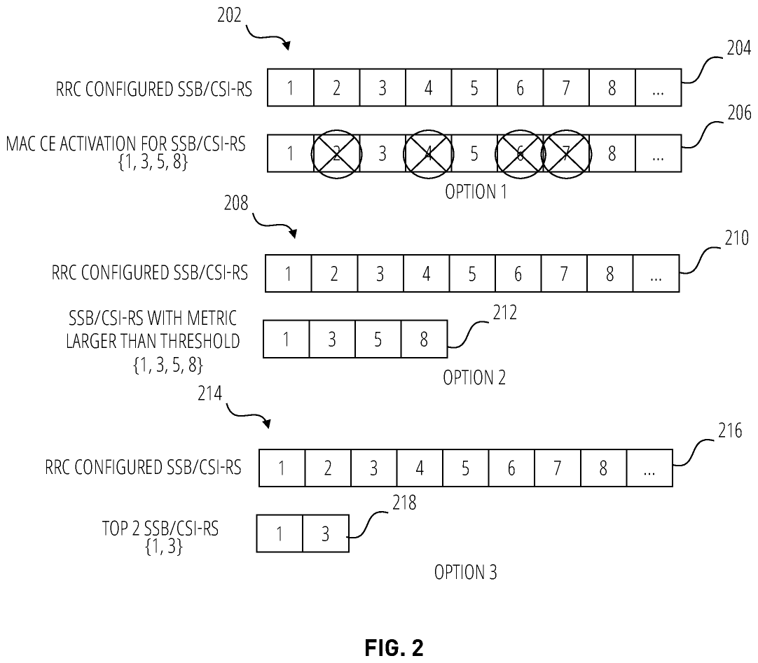

FIG. 2 illustrates block diagrams of three options for limiting a number of beams for P-MPR measurements. Some UEs may not be capable of measurement P-MPR for many beams at a time because P-MPR measurement complexity is high. For example, a UE may only be able to measure 4 SSBs/CSI-RSs within a given time. FIG. 2 illustrates some procedures for reducing the number of beams for the UE to measure P-MPR. The number of measured beams for P-MPR could be limited due to UE complexity (e.g. UE may only be able to measure four SSBs/CSI-RSs within a given time) to avoid RRC reconfiguration for the SSB/CSI-RS pool.

Limiting the number of measured beams for P-MPR may be based on one of: a MAC CE; a L1-RSRP, modified L1-RSRP, or virtual PHR threshold; or a group of SSBs/CSI-RS with a highest L1-RSRP, modified L1-RSRP, or virtual PHR.

In a first embodiment, a MAC CE can be introduced to update the SSB/CSI-RS pool for P-MPR measurement and report. The network node may send this MAC CE to the UE. For instance, one option for updating the SSB/CSI-RS pool for P-MPR measurement would be for the network node to use an RRC to configure the candidate SSB/CSI-RS resources, and the network node may use a MAC CE is used to down-select some of the resources. Another option may be for the MAC CE to contain a bit map to indicate the activation/deactivation status for the SSB/CSI-RS configured by RRC, and the UE would only measure the P-MPR for the activated SSB/CSI-RS resources. As shown in option one 202, a communication system using this first embodiment may configure a set of SSBs/CSI-RSs 204 via RRC. A MAC CE may then be used to generate an updated SSB/CSI-RS pool 206 for P-MPR measurement by activating some SSBs/CSI-RSs (e.g., 1, 3, 5, and 8) and deactivating other SSBs/CSI-RSs (2, 4, 6, and 7). The UE then may only measure the P-MPR for the activated SSB/CSI-RS resources (e.g., 1, 3, 5, and 8).

In a second embodiment, the UE may only measure the P-MPR for SSBs/CSI-RS with L1-RSRP, modified L1-RSRP, or virtual PHR larger than a threshold. The threshold may be configured by a network node. As shown in option two 208, a communication system using this second embodiment may configure a set of SSBs/CSI-RSs 210 via RRC. Then, the UE may compare L1-RSRP, modified L1-RSRP, or virtual PHR of each SSBs/CSI-RSs 210 to a threshold. Any SSB/CSI-RS with a L1-RSRP, modified L1-RSRP, or virtual PHR larger than the threshold may be used as an updated SSB/CSI-RS pool 212 for P-MPR measurement. The UE then may only measure the P-MPR for the SSBs/CSI-RSs in the updated SSB/CSI-RS pool 212.

In a third embodiment, the UE only measures the P-MPR for the top M (where M is a number) SSBs/CSI-RSs with the highest L1-RSRP, modified L1-RSRP, or virtual PHR. M may be preconfigured or set by the network node. As shown in option three 214, a communication system using this third embodiment may configure a set of SSBs/CSI-RSs 216 via RRC. Then, the UE may compare L1-RSRP, modified L1-RSRP, or virtual PHR of each SSBs/CSI-RSs 216 to each other. In the illustrated embodiment, the top two SSBs/CSI-RSs with the highest L1-RSRP, modified L1-RSRP, or virtual PHR may be used as an updated SSB/CSI-RS pool 218 for P-MPR measurement. The UE then may only measure the P-MPR for the SSBs/CSI-RSs in the updated SSB/CSI-RS pool 218.

In a fourth embodiment, a maximum number of measured SSBs/CSI-RSs may be reported through a UE capability report. The maximum number may be denoted as ‘M’. In addition, the SSB/CSI-RSs for L1-RSRP measurement may be configured by the network node. Once P-MPR exceeds a threshold configured by network node, the UE may report L1-RSRP for all SSB/CSI-RSs that the network node configured for monitoring.

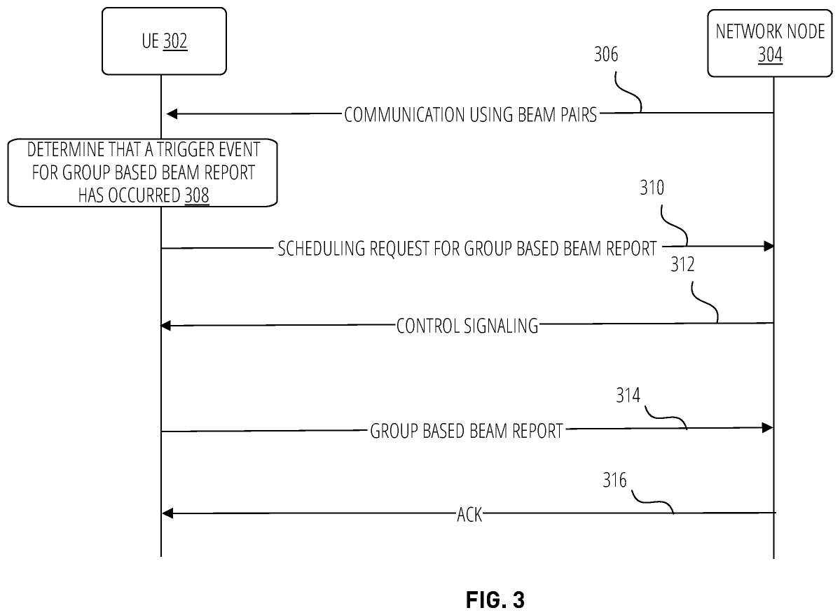

FIG. 3 is a simplified signal flow diagram of an example method for triggering a group based beam report from the UE 302. The UE 302 may be configured to receive communications from the network node 304 using beam pairs 306 based on an initial enhanced group based beam report.

However, after an initial enhanced group based beam report something may change and the UE 302 may not be able to receive a reported beam pair. For example, due to rotation or movement of the UE 302, UE 302 may not always receive the beam pairs with one panel or two panels as reported. The UE 302 may determine 308 that a trigger event for group based beam report has occurred. The UE 302 may send a scheduling request 310 for group based beam report to the network node 304. The scheduling request 310 may be dedicatedly configured for group based beam report triggering. When the network node 104 receives the scheduling request 310, the network node 304 may send control signaling to trigger the beam report for the UE 302 to receive. The control signaling may be a Downlink Control Information (DCI).

When the UE 302 receives the control signaling 312, the UE may report a group based beam report 314 to the network node 304. For example, the UE 302 may report the group based beam report 314 by Uplink Control Information (UCI) or MAC CE. The group based beam report 314 can be an absolute report or delta to a previous report. The network node 304 may send an acknowledge 316 for the beam report for the UE 302 to receive. In some embodiments, the acknowledge 316 may be sent by DCI. Alternatively, in some embodiments, the UE 302 may report the group based beam report by Uplink MAC CE and the network node 304 can further acknowledge the beam report by DCI or MAC-CE.

The UE 302 can determine 308 that the trigger event happened in a variety of ways. The following provide examples of when trigger events that can cause the UE to trigger (e.g., send the scheduling request 310) the group based beam report. For example, in a first embodiment, a UE 302 can trigger the group based beam report when there is a change in the maximum number of DL layers or status for same or different panels to receive a pair of beam as reported in the last beam report. For example, if the UE 302 had reported that beam one and beam two are received by two different panels and the subsequently the UE 302 cannot receive beam one and beam two on two different panels (e.g., due to rotation or power saving the UE 302 can only receive using one pane), the UE 302 can trigger the group based beam report.

In a second embodiment, the UE 302 can trigger the group based beam report when a difference for measured L1-RSRP from two UE 302 panels is above a threshold for one of the beams reported in the last beam report. The threshold may be configured by RRC.

In a third embodiment, the UE 302 can trigger the group based beam report when the maximum number of DL layers or status for same or different panels to receive SSBs/CSI-RSs indicated by a pair of active TCI States changed. The pair of active TCI States may indicate the TCI States applied for the downlink signals that may potentially require UE to receive simultaneously.

In a fourth embodiment, the UE 302 can trigger the group based beam report when a difference for measured L1-RSRP from two UE panels is above a threshold for one of the beams indicated by active TCI States. The threshold may be configured by the RRC.

In a fifth embodiment an effective window may be defined for a beam report. In this embodiment, the simultaneous reception status is only valid within this effective window. The effective window may start after the last symbol of a group based beam report. After the effective window the beam report is outdated. The size of the effective window may be configured in a variety of ways. In some embodiments, the size of the effective window may be predefined. In other embodiments, the effective window is reported by UE capability. In yet other embodiments, the effective window is configured by RRC signaling. In yet other embodiments the effective window is determined by next group based beam report instance. For example, the latest beam reporting instance may override the status for the last beam reporting instance.

Either the network node 304 or the UE 302 may trigger the group based beam report. For example, in some embodiments, the network node 304 can trigger the group based beam report after the last beam report expires. Additionally, in some embodiments, UE 302 can trigger the group based beam report if the effective window expires.

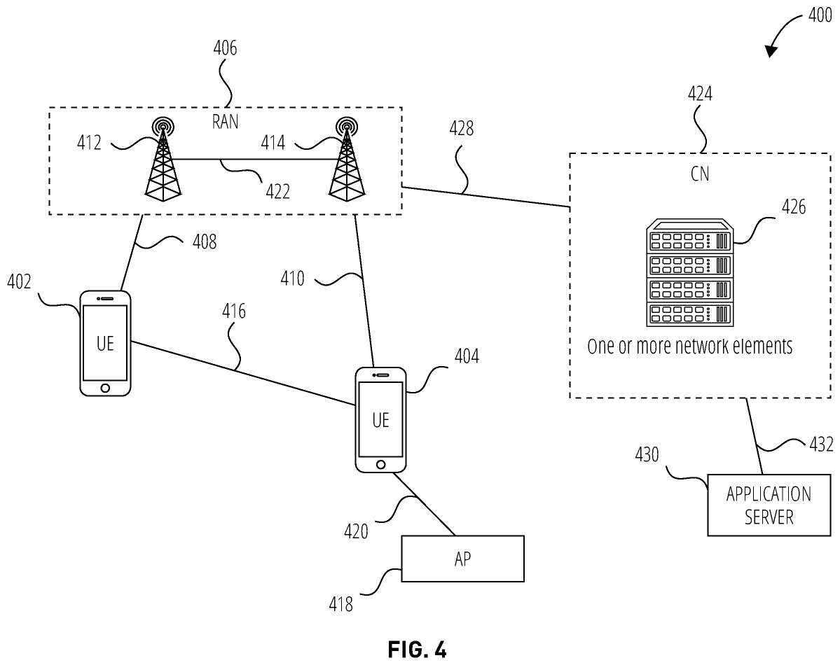

FIG. 4 illustrates an example architecture of a wireless communication system 400, according to embodiments disclosed herein. The following description is provided for an example wireless communication system 400 that operates in conjunction with the LTE system standards and/or 5G or NR system standards as provided by 3GPP technical specifications.

As shown by FIG. 4, the wireless communication system 400 includes UE 402 and UE 404 (although any number of UEs may be used). In this example, the UE 402 and the UE 404 are illustrated as smartphones (e.g., handheld touchscreen mobile computing devices connectable to one or more cellular networks), but may also comprise any mobile or non-mobile computing device configured for wireless communication.

The UE 402 and UE 404 may be configured to communicatively couple with a RAN 406. In embodiments, the RAN 406 may be NG-RAN, E-UTRAN, etc. The UE 402 and UE 404 utilize connections (or channels) (shown as connection 408 and connection 410, respectively) with the RAN 406, each of which comprises a physical communications interface. The RAN 406 can include one or more base stations, such as base station 412 and base station 414, that enable the connection 408 and connection 410.

In this example, the connection 408 and connection 410 are air interfaces to enable such communicative coupling, and may be consistent with RAT(s) used by the RAN 406, such as, for example, an LTE and/or NR.

In some embodiments, the UE 402 and UE 404 may also directly exchange communication data via a sidelink interface 416. The UE 404 is shown to be configured to access an access point (shown as AP 418) via connection 420. By way of example, the connection 420 can comprise a local wireless connection, such as a connection consistent with any IEEE 802.11 protocol, wherein the AP 418 may comprise a Wi-Fi® router. In this example, the AP 418 may be connected to another network (for example, the Internet) without going through a CN 424.

In embodiments, the UE 402 and UE 404 can be configured to communicate using orthogonal frequency division multiplexing (OFDM) communication signals with each other or with the base station 412 and/or the base station 414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 412 or base station 414 may be implemented as one or more software entities running on server computers as part of a virtual network. In addition, or in other embodiments, the base station 412 or base station 414 may be configured to communicate with one another via interface 422. In embodiments where the wireless communication system 400 is an LTE system (e.g., when the CN 424 is an EPC), the interface 422 may be an X2 interface. The X2 interface may be defined between two or more base stations (e.g., two or more eNBs and the like) that connect to an EPC, and/or between two eNBs connecting to the EPC. In embodiments where the wireless communication system 400 is an NR system (e.g., when CN 424 is a 5GC), the interface 422 may be an Xn interface. The Xn interface is defined between two or more base stations (e.g., two or more gNBs and the like) that connect to 5GC, between a base station 412 (e.g., a gNB) connecting to 5GC and an eNB, and/or between two eNBs connecting to 5GC (e.g., CN 424).

The RAN 406 is shown to be communicatively coupled to the CN 424. The CN 424 may comprise one or more network elements 426, which are configured to offer various data and telecommunications services to customers/subscribers (e.g., users of UE 402 and UE 404) who are connected to the CN 424 via the RAN 406. The components of the CN 424 may be implemented in one physical device or separate physical devices including components to read and execute instructions from a machine-readable or computer-readable medium (e.g., a non-transitory machine-readable storage medium).

In embodiments, the CN 424 may be an EPC, and the RAN 406 may be connected with the CN 424 via an S1 interface 428. In embodiments, the S1 interface 428 may be split into two parts, an S1 user plane (S1-U) interface, which carries traffic data between the base station 412 or base station 414 and a serving gateway (S-GW), and the S1-MME interface, which is a signaling interface between the base station 412 or base station 414 and mobility management entities (MMEs).

In embodiments, the CN 424 may be a 5GC, and the RAN 406 may be connected with the CN 424 via an NG interface 428. In embodiments, the NG interface 428 may be split into two parts, an NG user plane (NG-U) interface, which carries traffic data between the base station 412 or base station 414 and a user plane function (UPF), and the S1 control plane (NG-C) interface, which is a signaling interface between the base station 412 or base station 414 and access and mobility management functions (AMFs).

Generally, an application server 430 may be an element offering applications that use internet protocol (IP) bearer resources with the CN 424 (e.g., packet switched data services). The application server 430 can also be configured to support one or more communication services (e.g., VOIP sessions, group communication sessions, etc.) for the UE 402 and UE 404 via the CN 424. The application server 430 may communicate with the CN 424 through an IP communications interface 432.

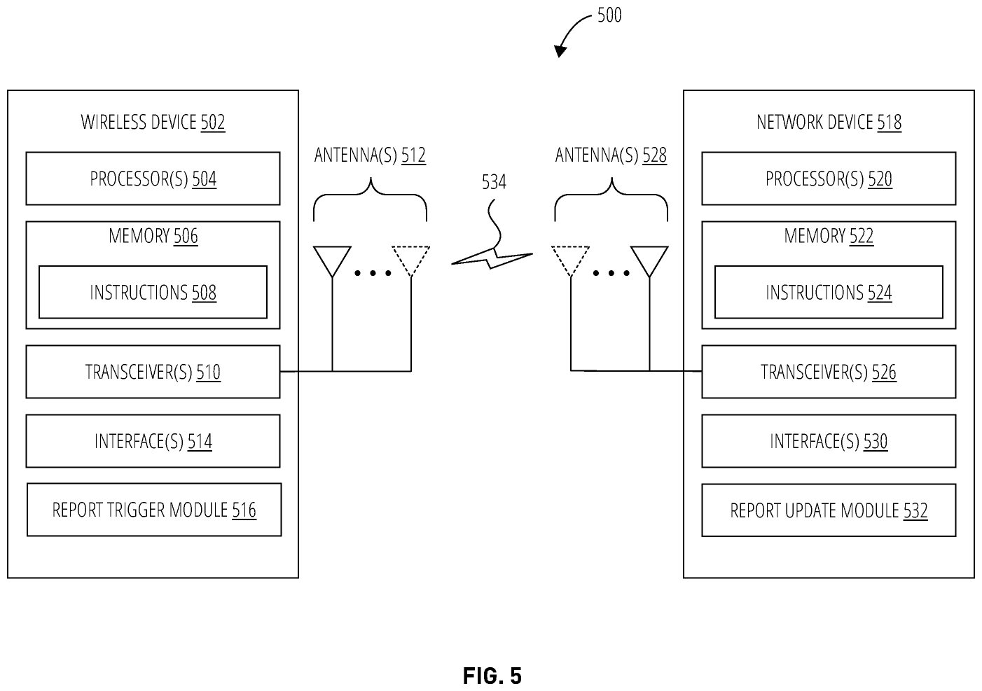

FIG. 5 illustrates a system 500 for performing signaling 534 between a wireless device 502 and a network device 518, according to embodiments disclosed herein. The system 500 may be a portion of a wireless communications system as herein described. The wireless device 502 may be, for example, a UE of a wireless communication system. The network device 518 may be, for example, a base station (e.g., an eNB or a gNB) of a wireless communication system.

The wireless device 502 may include one or more processor(s) 504. The processor(s) 504 may execute instructions such that various operations of the wireless device 502 are performed, as described herein. The processor(s) 504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 502 may include a memory 506. The memory 506 may be a non-transitory computer-readable storage medium that stores instructions 508 (which may include, for example, the instructions being executed by the processor(s) 504). The instructions 508 may also be referred to as program code or a computer program. The memory 506 may also store data used by, and results computed by, the processor(s) 504.

The wireless device 502 may include one or more transceiver(s) 510 that may include radio frequency (RF) transmitter and/or receiver circuitry that use the antenna(s) 512 of the wireless device 502 to facilitate signaling (e.g., the signaling 534) to and/or from the wireless device 502 with other devices (e.g., the network device 518) according to corresponding RATs.

The wireless device 502 may include one or more antenna(s) 512 (e.g., one, two, four, or more). For embodiments with multiple antenna(s) 512, the wireless device 502 may leverage the spatial diversity of such multiple antenna(s) 512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 502 may be accomplished according to precoding (or digital beamforming) that is applied at the wireless device 502 that multiplexes the data streams across the antenna(s) 512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 502 may implement analog beamforming techniques, whereby phases of the signals sent by the antenna(s) 512 are relatively adjusted such that the (joint) transmission of the antenna(s) 512 can be directed (this is sometimes referred to as beam steering).

The wireless device 502 may include one or more interface(s) 514. The interface(s) 514 may be used to provide input to or output from the wireless device 502. For example, a wireless device 502 that is a UE may include interface(s) 514 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 510/antenna(s) 512 already described) that allow for communication between the UE and other devices and may operate according to known protocols (e.g., Wi-Fi®, Bluetooth®, and the like).

The wireless device 502 may include a report trigger module 516. The report trigger module 516 may be implemented via hardware, software, or combinations thereof. For example, the report trigger module 516 may be implemented as a processor, circuit, and/or instructions 508 stored in the memory 506 and executed by the processor(s) 504. In some examples, the report trigger module 516 may be integrated within the processor(s) 504 and/or the transceiver(s) 510. For example, the report trigger module 516 may be implemented by a combination of software components (e.g., executed by a DSP or a general processor) and hardware components (e.g., logic gates and circuitry) within the processor(s) 504 or the transceiver(s) 510.

The report trigger module 516 may be used for various aspects of the present disclosure, for example, aspects of FIGS. 1-3. The report trigger module 516 is configured to trigger a P-MPR report and trigger a group based beam report.

The network device 518 may include one or more processor(s) 520. The processor(s) 520 may execute instructions such that various operations of the network device 518 are performed, as described herein. The processor(s) 520 may include one or more baseband processors implemented using, for example, a CPU, a DSP, an ASIC, a controller, an FPGA device, another hardware device, a firmware device, or any combination thereof configured to perform the operations described herein.

The network device 518 may include a memory 522. The memory 522 may be a non-transitory computer-readable storage medium that stores instructions 524 (which may include, for example, the instructions being executed by the processor(s) 520). The instructions 524 may also be referred to as program code or a computer program. The memory 522 may also store data used by, and results computed by, the processor(s) 520.

The network device 518 may include one or more transceiver(s) 526 that may include RF transmitter and/or receiver circuitry that use the antenna(s) 528 of the network device 518 to facilitate signaling (e.g., the signaling 534) to and/or from the network de vice 518 with other devices (e.g., the wireless device 502) according to corresponding RATs.

The network device 518 may include one or more antenna(s) 528 (e.g., one, two, four, or more). In embodiments having multiple antenna(s) 528, the network device 518 may perform MIMO, digital beamforming, analog beamforming, beam steering, etc., as has been described.

The network device 518 may include one or more interface(s) 530. The interface(s) 530 may be used to provide input to or output from the network device 518. For example, a network device 518 that is a base station may include interface(s) 530 made up of transmitters, receivers, and other circuitry (e.g., other than the transceiver(s) 526/antenna(s) 528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 518 may include a report update module 532. The report update module 532 may be implemented via hardware, software, or combinations thereof. For example, the report update module 532 may be implemented as a processor, circuit, and/or instructions 524 stored in the memory 522 and executed by the processor(s) 520. In some examples, the report update module 532 may be integrated within the processor(s) 520 and/or the transceiver(s) 526. For example, the report update module 532 may be implemented by a combination of software components (e.g., executed by a DSP or a general processor) and hardware components (e.g., logic gates and circuitry) within the processor(s) 520 or the transceiver(s) 526.

The report update module 532 may be used for various aspects of the present disclosure, for example, aspects of FIGS. 1-3. The report update module 532 is configured to receive updates for a P-MPR report and a group based beam report.

Embodiments contemplated herein include an apparatus comprising means to perform one or more elements of the methods shown in FIG. 1 and FIG. 3. This apparatus may be, for example, an apparatus of a UE (such as a wireless device 502 that is a UE, as described herein).

Embodiments contemplated herein include one or more non-transitory computer-readable media comprising instructions to cause an electronic device, upon execution of the instructions by one or more processors of the electronic device, to perform one or more elements of the methods shown in FIG. 1 and FIG. 3. This non-transitory computer-readable media may be, for example, a memory of a UE (such as a memory 506 of a wireless device 502 that is a UE, as described herein).

Embodiments contemplated herein include an apparatus comprising logic, modules, or circuitry to perform one or more elements of the methods shown in FIG. 1 and FIG. 3. This apparatus may be, for example, an apparatus of a UE (such as a wireless device 502 that is a UE, as described herein).

Embodiments contemplated herein include an apparatus comprising: one or more processors and one or more computer-readable media comprising instructions that, when executed by the one or more processors, cause the one or more processors to perform one or more elements of the methods shown in FIG. 1 and FIG. 3. This apparatus may be, for example, an apparatus of a UE (such as a wireless device 502 that is a UE, as described herein).

Embodiments contemplated herein include a signal as described in or related to one or more elements of the methods shown in FIG. 1 and FIG. 3.

Embodiments contemplated herein include a computer program or computer program product comprising instructions, wherein execution of the program by a processor is to cause the processor to carry out one or more elements of the methods shown in FIG. 1 and FIG. 3. The processor may be a processor of a UE (such as a processor(s) 504 of a wireless device 502 that is a UE, as described herein). These instructions may be, for example, located in the processor and/or on a memory of the UE (such as a memory 506 of a wireless device 502 that is a UE, as described herein).

Embodiments contemplated herein include an apparatus comprising means to perform one or more elements of the methods shown in FIG. 1 and FIG. 3. This apparatus may be, for example, an apparatus of a base station (such as a network device 518 that is a base station, as described herein).

Embodiments contemplated herein include one or more non-transitory computer-readable media comprising instructions to cause an electronic device, upon execution of the instructions by one or more processors of the electronic device, to perform one or more elements of the methods shown in FIG. 1 and FIG. 3. This non-transitory computer-readable media may be, for example, a memory of a base station (such as a memory 522 of a network device 518 that is a base station, as described herein).

Embodiments contemplated herein include an apparatus comprising logic, modules, or circuitry to perform one or more elements of the methods shown in FIG. 1 and FIG. 3. This apparatus may be, for example, an apparatus of a base station (such as a network device 518 that is a base station, as described herein).

Embodiments contemplated herein include an apparatus comprising: one or more processors and one or more computer-readable media comprising instructions that, when executed by the one or more processors, cause the one or more processors to perform one or more elements of the methods shown in FIG. 1 and FIG. 3. This apparatus may be, for example, an apparatus of a base station (such as a network device 518 that is a base station, as described herein).

Embodiments contemplated herein include a signal as described in or related to one or more elements of the methods shown in FIG. 1 and FIG. 3.

Embodiments contemplated herein include a computer program or computer program product comprising instructions, wherein execution of the program by a processing element is to cause the processing element to carry out one or more elements of the methods shown in FIG. 1 and FIG. 3. The processor may be a processor of a base station (such as a processor(s) 520 of a network device 518 that is a base station, as described herein). These instructions may be, for example, located in the processor and/or on a memory of the base station (such as a memory 522 of a network device 518 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The invention claimed is:

1. A method for a user equipment (UE), the method comprising:
transmitting using multiple beams;
identifying a power management maximum power reduction (P-MPR) reference based on one or more of the multiple beams;
monitoring the P-MPR reference for changes in a P-MPR value; and
triggering a P-MPR report procedure for the multiple beams based on the changes in the P-MPR value associated with the P-MPR reference.

2. The method of claim 1, wherein the one or more of the multiple beams to be used for the P-MPR reference comprises one Synchronization Signal Block (SSBs) or Channel-State Information Reference Signal (CSI-RS) out of a pool of SSBs or CSI-RSs configured by Radio Resource Control (RRC) signaling,
wherein monitoring the P-MPR reference for changes in the P-MPR value comprises comparing the P-MPR value for the one SSB or CSI-RS to a mpe-threshold and comparing a P-MPR change for the one SSB or CSI-RS to a change threshold, and
wherein the P-MPR report procedure is triggered when the P-MPR value is greater than or equal to the mpe-threshold or the P-MPR change is greater than or equal to the change threshold.

3. The method of claim 2, wherein the mpe-threshold and the change threshold are configured by the RRC signaling.

4. The method of claim 2, wherein any of the pool of SSBs or CSI-RSs configured by RRC is used as the one SSB or CSI-RS.

5. The method of claim 2, wherein the one SSB or CSI-RS is any one of a set of SSBs or CSI-RSs reported by a Medium Access Control Coverage Enhancement (MAC CE).

6. The method of claim 2, wherein the one SSB or CSI-RS has a highest Layer 1 (L1) Reference Signal Received Power (RSRP), a highest modified L1-RSRP, or a highest virtual power headroom report (PHR) among the SSBs or CSI-RSs configured by Radio Resource Control (RRC).

7. The method of claim 2, wherein the one SSB or CSI-RS is a SSB or CSI-RS with a L1-RSRP, modified L1-RSRP, or virtual PHR larger than a threshold configured by a network node.

8. The method of claim 2, wherein the UE supports multiple selection options for the one SSB or CSI-RS, and wherein selection among the options is based on RRC configuration.

9. The method of claim 1, wherein the one or more of the multiple beams to be used for the P-MPR reference comprises two or more SSBs or CSI-RSs out of a pool of SSBs or CSI-RSs configured by RRC,
wherein monitoring the P-MPR reference for changes in the P-MPR value comprises comparing a maximum, minimal, or average P-MPR value for the two or more SSBs or CSI-RSs to a mpe-threshold and comparing a maximum, minimal, or average P-MPR change for the two or more SSBs or CSI-RSs to a change threshold, and
wherein the P-MPR report procedure is triggered when the maximum, minimal, or average P-MPR value is greater than or equal to the mpe-threshold or the maximum, minimal, or average P-MPR change is greater than or equal to the change threshold.

10. The method of claim 9, wherein the two or more SSBs or CSI-RSs comprise all of the SSBs or CSI-RSs configured by RRC.

11. The method of claim 9, wherein the two or more SSBs or CSI-RSs comprise SSBs or CSI-RSs with a L1-RSRP, modified L1-RSRP, or virtual PHR larger than a threshold configured by a network node.

12. The method of claim 1, wherein the one or more of the multiple beams to be used for the P-MPR reference comprises one SSB or CSI-RS configured in an active UL or joint TCI State,
wherein monitoring the P-MPR reference for changes in the P-MPR value comprises comparing the P-MPR value for the one SSB or CSI-RS to a mpe-threshold and comparing a P-MPR change for the one SSB or CSI-RS to a change threshold, and
wherein the P-MPR report procedure is triggered when the P-MPR value is greater than or equal to the mpe-threshold or the P-MPR change is greater than or equal to the change threshold.

13. The method of claim 1, further comprising limiting a number of measured beams for P-MPR based on one of:
a MAC CE,
a L1-RSRP, modified L1-RSRP, or virtual PHR threshold, or
a group of SSBs/CSI-RS with a highest of the L1-RSRP, the modified L1-RSRP, or the virtual PHR.

14. A method for a user equipment (UE), the method comprising:
receiving using a pair of beams;
determining that a trigger event for a group based beam report has occurred;
sending a scheduling request (SR) to a network node, wherein the SR is configured for group based beam report triggering;
receiving, from the network node, a control signaling to trigger the group based beam report; and
reporting the group based beam report to the network node.

15. The method of claim 14, further comprising receiving, by downlink control information (DCI) from a base station, an acknowledge from the network node for the group based beam report.

16. The method of claim 14, wherein the trigger event occurs when a maximum number of DL layers or status for same or different panels to receive the pair of beams in a last beam report changes.

17. The method of claim 14, wherein the trigger event occurs when a difference for measured L1-RSRP from two UE panels is above a threshold for one beam reported in a last beam report.

18. The method of claim 14, wherein the trigger event occurs when a maximum number of DL layers or status for same or different panels to receive SSBs or CSI-RSs indicated by a pair of active TCI States changes.

19. The method of claim 14, wherein the trigger event occurs when a difference for measured L1-RSRP from two UE panels is above a threshold for one beam indicated by active TCI States.

20. The method of claim 14, wherein the trigger event occurs based on an effective window, wherein simultaneous reception status is only valid within the effective window, and wherein the effective window starts after a last symbol of any group based beam report.
